(19) United States
(12) Patent Application Publication
(10) Pub. No.: US 2015/0093179 A1
(43) Pub. Date: Apr. 2, 2015

(54) ELASTIC APERTURE ALIGNMENT SYSTEM FOR PROVIDING PRECISE FOUR-WAY ALIGNMENT OF COMPONENTS

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US)

(73) Assignee: GM GLOBAL TECHNOLOGY OPERATIONS LLC, Detroit, MI (US)

(21) Appl. No.: 14/044,207

(22) Filed: Oct. 2, 2013

(51) Int. Cl. B62D 27/02; B62D 27/06

(52) U.S. Cl. CPC B62D 27/02; B62D 27/06
USPC 403/13

(57) ABSTRACT

An elastically averaged alignment system includes a first component having a first alignment member and an alignment element fixedly disposed with respect to and extending outward from a surface of the first alignment member, and a second component having a second alignment member and an elastically deformable alignment aperture fixedly disposed with respect to the second alignment member. The elastically deformable alignment aperture is configured and disposed to interferingly, deformably and matingly engage with the alignment element. The elastically deformable alignment aperture includes three or more elastically deformable alignment features. When the alignment element is inserted into the elastically deformable alignment aperture, portions of the three or more elastically deformable alignment features elastically deform to an elastically averaged final configuration that aligns the first alignment member with the second alignment member in four planar orthogonal directions.

### FIELD OF THE INVENTION

The subject invention relates to the art of alignment systems, more particularly to an elastically averaged alignment system, and even more particularly to an elastically averaged alignment system providing four-way alignment of mating components on which the alignment system is incorporated via an elastically deformable alignment aperture.

### BACKGROUND

Currently, components, particularly vehicular components such as those found in automotive vehicles, which are to be mated together in a manufacturing process are mutually located with respect to each other by alignment features that are oversized and/or undersized to provide spacing to freely move the components relative to one another to align them without creating an interference therebetween that would hinder the manufacturing process. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components having the aforementioned alignment features, which may contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality.

Accordingly, the art of alignment systems can be enhanced by providing an alignment system or mechanism that can ensure precise four-way alignment of two components via elastic averaging of a single elastically deformable alignment aperture disposed in mating engagement with a corresponding single alignment element.

### SUMMARY OF THE INVENTION

In an exemplary embodiment of the invention, an elastically averaged alignment system includes a first component having a first alignment member and an alignment element fixedly disposed with respect to and extending outward from a surface of the first alignment member, and a second component having a second alignment member and an elastically deformable alignment aperture fixedly disposed with respect to the second alignment member. The elastically deformable alignment aperture is configured and disposed to interferingly, deformably and matingly engage with the alignment element. The elastically deformable alignment aperture includes three or more elastically deformable alignment features. When the alignment element is inserted into the elastically deformable alignment aperture, portions of the three or more elastically deformable alignment features elastically deform to an elastically averaged final configuration that aligns the first alignment member with the second alignment member in four planar orthogonal directions.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts an elastically averaged alignment system in accordance with an embodiment of the invention;

FIG. 2 depicts an elastically deformable alignment aperture prior to engagement with an alignment element, in accordance with an embodiment of the invention;

FIG. 3 depicts the elastically deformable alignment aperture of FIG. 2 disposed in full engagement with the alignment element of FIG. 2, in accordance with an embodiment of the invention;

FIG. 4 depicts another elastically deformable alignment aperture alternative to that of FIG. 2 prior to engagement with an alignment element, in accordance with an embodiment of the invention;

FIG. 5 depicts the elastically deformable alignment aperture of FIG. 4 disposed in full engagement with the alignment element of FIG. 4, in accordance with an embodiment of the invention;

FIG. 6 depicts an elastically averaged alignment system similar to that of FIG. 1, but with a plurality of alignment elements and corresponding alignment apertures depicted generically, in accordance with an embodiment of the invention; and

FIG. 7 depicts a vehicle employing an elastically averaged alignment system of FIG. 1 or FIG. 6, in accordance with an embodiment of the invention.

### DESCRIPTION OF THE EMBODIMENTS

The following description is merely exemplary in nature and is not intended to limit the present disclosure, its application or uses. For example, the embodiments shown may comprise portions of a vehicle, but the alignment system may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, now U.S. Publication No. U.S. 2013-0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed employing an elastically deformable alignment aperture, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

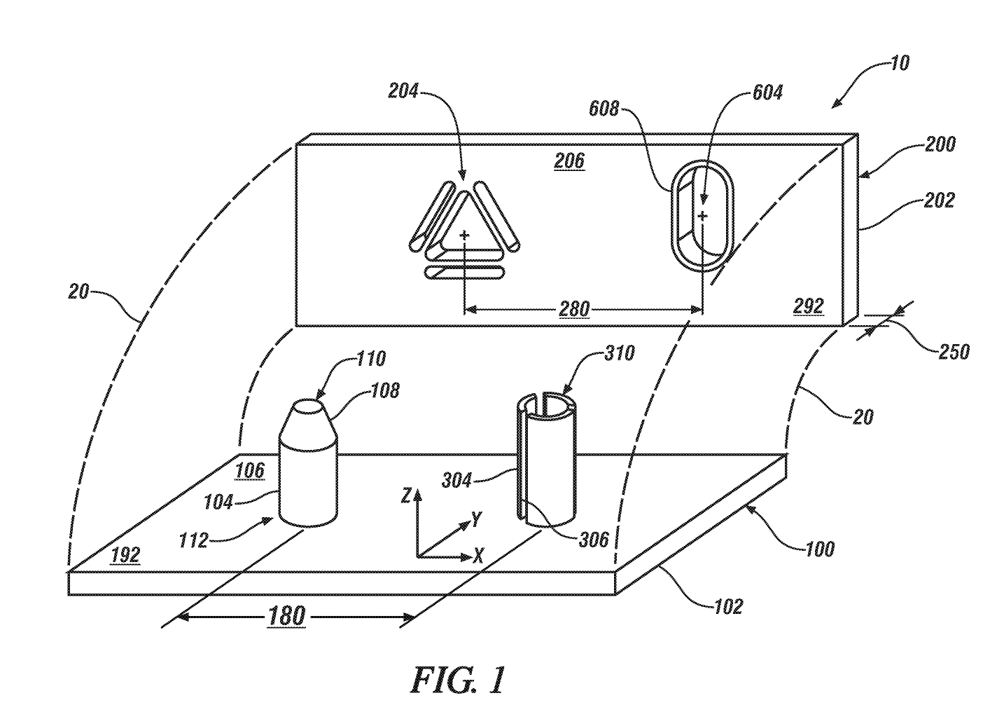

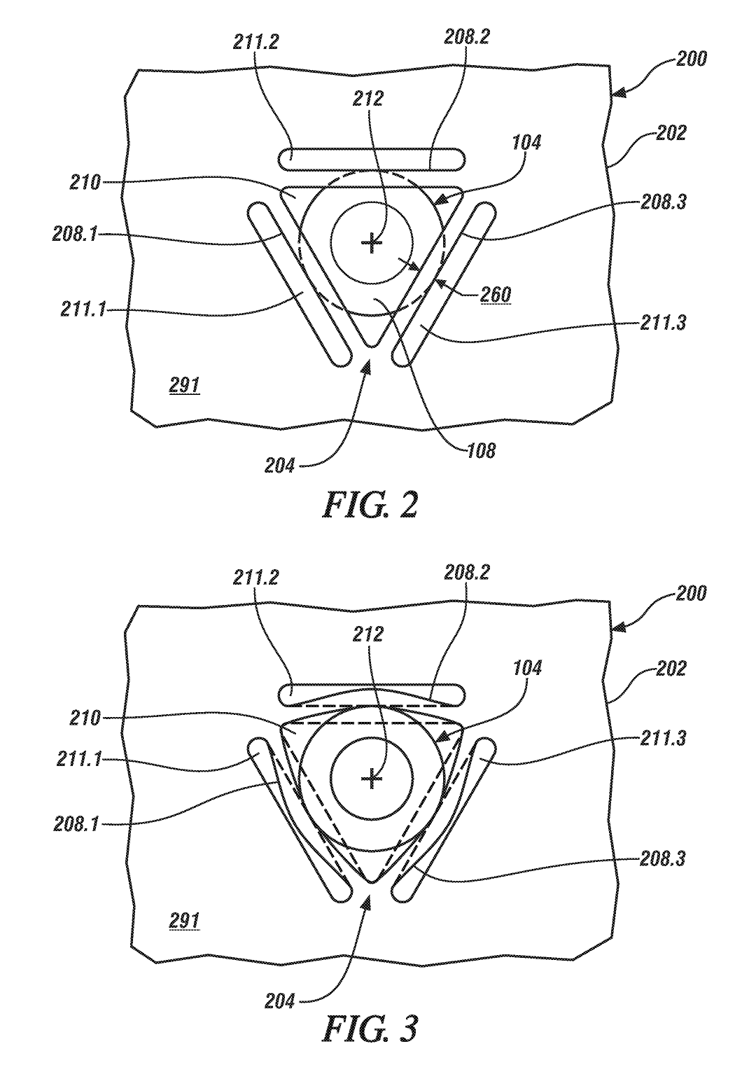

In accordance with an exemplary embodiment of the invention, and with reference to FIG. 1, an elastically averaging alignment system 10 includes a first component 100 having a first alignment member 102 and an alignment element 104 fixedly disposed with respect to and extending outward from a surface 106 of the first alignment member 102, and a second component 200 having a second alignment member 202 with a thickness “250” and an elastically deformable alignment aperture 204 pierced through the thickness “250” and fixedly disposed with respect to the second alignment member 202. The elastically deformable alignment aperture 204 is configured and disposed to interferingly, deformably and matingly engage the alignment element 104, in a manner discussed in more detail below, to precisely align the first component 100 with the second component 200 in four directions, such as the +/−x-direction and the +/−y-direction of an orthogonal coordinate system, for example, which is herein referred to as four-way alignment. In an embodiment, the elastically deformable alignment aperture 204 has three or more elastically deformable alignment features 208.1, 208.2, 208.3, each being configured as an elastically deformable fixed beam that is fixed at each respective end and free to deflect in the respective center (best seen with reference to FIG. 2), and the alignment element 104 is an elongated solid circular pin (also herein referred to by reference numeral 104). The alignment element 104 and the elastically deformable alignment aperture 204 are herein also referred to as male and female mating features, respectively. In an embodiment, a chamfer 108 at a distal end 110 of the alignment element 104 is employed to facilitate insertion of the element into the elastically deformable alignment aperture 204; the proximal end 112 of the alignment element 104 being proximate the surface 106 of the first alignment member 102. When the alignment element 104 is inserted into the elastically deformable alignment aperture 204, portions of the three or more elastically deformable alignment features 208.1, 208.2, 208.3 elastically deform to an elastically averaged final configuration that aligns the first alignment member 102 with the second alignment member 202 in four planar orthogonal directions.

For discussion purposes, the mating side of the first alignment member 102 visible in FIG. 1 is labeled “192”, and the mating side of the second alignment member 202 visible in FIG. 1 is labeled “292”. The non-visible sides of the first and second alignment members 102, 202 that are hidden from view in FIG. 1 are herein referred to by reference labels “191” and “291”, respectively. For discussion purposes, the “192” and “292” sides are herein referred to as front views, and the “191” and “291” sides are herein referred to as rear views. Dashed lines 20 represent direction lines that may be traversed as the first and second components 100, 200 are assembled with respect to each other.

Reference is now made to FIGS. 2 and 3 in combination with FIG. 1, where FIG. 2 depicts a rear plan view from the “291” side of the second alignment member 202 of the alignment system 10 with the second component 200 poised to mate with the first component 100 just prior to insertion of the alignment element 104 in the elastically deformable alignment aperture 204, and FIG. 3 depicts the same rear plan view as depicted in FIG. 2 but with the second component 200 mated with the first component 100 with the alignment element 104 fully engaged with the elastically deformable alignment aperture 204.

In the embodiment depicted in FIGS. 1 and 2, the elastically deformable alignment features (elastically deformable fixed beams) 208.1, 208.2, 208.3 are each disposed to form one side of an equilateral triangle shape, and are formed by four openings 210, 211.1, 211.2, 211.3 cut into the second component 200, the first opening 210 being the opening that the alignment element 104 is inserted into, and the second through fourth openings 211.1, 211.2, 211.3 being relief openings that permit the elastically deformable alignment features 208.1, 208.2, 208.3 to elastically deflect radially outward from a center 212 of the elastically deformable alignment aperture 204. While FIG. 2 depicts the elastically deformable alignment features 208.1, 208.2, 208.3 each disposed to form one side of an equilateral triangle shape, it will be appreciated that the scope of the invention is not so limited, and also encompasses other shapes suitable for a purpose disclosed herein, such as the elastically deformable alignment features 208.1, 208.2, 208.3 each having a concave or convex curvature relative the center 212 of the elastically deformable alignment aperture 204, for example.

As depicted in FIG. 2 just prior to insertion of the alignment element 104 into the elastically deformable alignment aperture 204, the outer circumference (depicted as an outer diameter) of the alignment element (depicted as an elongated circular pin) 104 has a purposeful interference of dimension “260” with each of the elastically deformable alignment features 208.1, 208.2, 208.3. And as depicted in FIG. 3 after full engagement of the alignment element 104 with the first opening 210 of the elastically deformable alignment aperture 204, the elastically deformable alignment features 208.1, 208.2, 208.3 have undergone an elastically averaged deflection into the relief openings 211.1, 211.2, 211.3 an amount sufficient to clear the interference dimension “260”, as indicated by dashed lines (un-deformed state) and solid lines (deformed state).

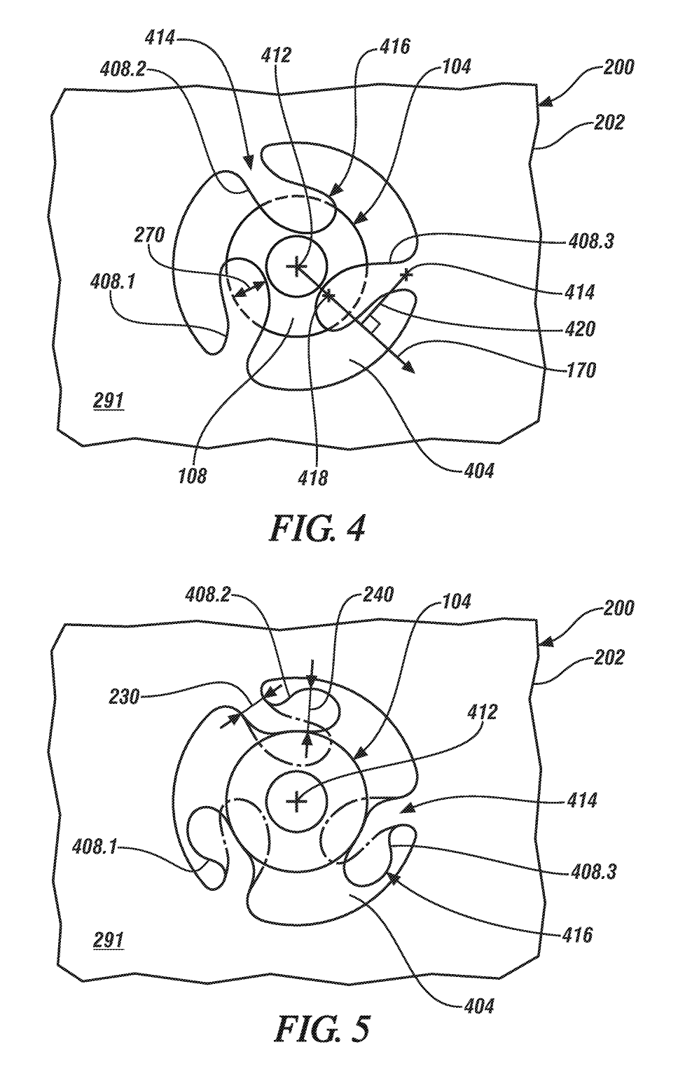

While FIGS. 1-3 depict a triangular shaped elastically deformable aperture 204, it will be appreciated that the scope of the invention is not so limited, and also encompasses other shapes suitable for a purpose disclosed herein, one of which will now be discussed with reference to FIGS. 4 and 5, which depict an alternative elastically deformable alignment aperture 404 that can be interchanged with the elastically deformable alignment aperture 204 in FIG. 1 for the same purpose previously described herein.

While FIGS. 1-3 depict only three elastically deformable alignment features 208.1, 208.2, 208.3, it will be appreciated that the scope of the invention is not so limited, and also encompasses an arrangement where the second alignment member 202 has more than three elastically deformable alignment features, such as four or five for example. Any number of elastically deformable alignment features suitable for a purpose disclosed herein is contemplated and considered within the scope of the invention.

FIG. 4 depicts a rear plan view from the “291” side of the second alignment member 202 of the alignment system 10 with the second component 200 poised to mate with the first component 100 just prior to insertion of the alignment element 104 in the alternative elastically deformable alignment aperture 404, and FIG. 5 depicts the same rear plan view as depicted in FIG. 4 but with the second component 200 mated with the first component 100 with the alignment element 104 fully engaged with the alternative elastically deformable alignment aperture 404.

In the embodiment depicted in FIG. 4, the elastically deformable aperture 404 has three elastically deformable alignment features in the form of three similarly shaped elastically deformable cantilever beams 408.1, 408.2, 408.3 that extend from an edge of the elastically deformable aperture 404 toward a center 412 of the elastically deformable aperture 404. Each elastically deformable cantilever beam 408.1, 408.2, 408.3 has a lobular shape (also herein referred to as lobes) having a fixed end 414 adjoined to the second alignment member 202, and a cantilevered free end 416 having an interference of dimension “270” with respect to the outer diameter of the alignment element 104. The cantilevered free end 416 also has a point of contact 418 with respect to the chamfer 108 of the alignment element 104 that creates a bending moment having a moment arm 420 relative to the fixed end 414 that exerts a force along a line of force “170” on each lobe 408.1, 408.2, 408.3 to elastically deflect the cantilevered free end 416 of each lobe 408.1, 408.2, 408.3 radially away from the center 412 of the elastically deformable aperture 404 during insertion of the alignment element 104 into the elastically deformable aperture 404, where the final fully inserted position of the lobes 408.1, 408.2, 408.3 is best seen with reference to FIG. 5, where the dashed lines indicated an un-deformed position, and the solid lines indicate a deformed position.

From the foregoing description relating to FIGS. 4 and 5, it will be appreciated that the line of force “170” also drives the distal end 416 of each lobe 408.1, 408.2, 408.3 circumferentially about the outer diameter of the alignment element 104 due to the deflecting action that each lobe 408.1, 408.2, 408.3 undergoes as it elastically deforms relative to its respective fixed end 414 during an assembly process. As depicted in FIG. 4 the circumferential deflection is clockwise about the center 412 of the elastically deformable aperture 404; however, it will be appreciated that the lobes 408.1, 408.2, 408.3 could be reversed in orientation to produce a counter-clockwise circumferential deflection during an assembly process.

Also from the foregoing description relating to FIGS. 4 and 5, it will be appreciated that friction between the lobes 408.1, 408.2, 408.3 and the alignment element 104 during an assembly process may cause each lobe 408.1, 408.2, 408.3 (more generally herein referred to as elastically deformable alignment features) to elastically deform axially with respect to a central axis of the alignment element 104.

To promote radial elastic deformation relative to the proximal end 414 of each lobe 408.1, 408.2, 408.3 during an assembly process, an embodiment is configured such that the proximal end 414 is smaller in cross section area than the respective distal end 416, which is represented in FIG. 5 by dimension “230” being smaller than dimension “240”, where in an embodiment the thickness of the two regions are the same. Alternatively, it will be appreciated that the proximal end 414 of each lobe 408.1, 408.2, 408.3 may be larger in cross section area than the respective distal end 416, which would promote more axial than radial elastic deformation of each lobe 408.1, 408.2, 408.3 during an assembly process.

While FIGS. 4-5 depict only three elastically deformable alignment lobes 408.1, 408.2, 408.3, it will be appreciated that the scope of the invention is not so limited, and also encompasses an arrangement where the second alignment member 202 has more than three elastically deformable alignment lobes, such as four or five for example. Any number of elastically deformable alignment lobes suitable for a purpose disclosed herein is contemplated and considered within the scope of the invention.

With reference now back to FIG. 1, it will be appreciated that the elastically averaged alignment system 10 may not be limited to just one alignment element 104 and one elastically deformable alignment aperture 204, but may include a plurality of such features or other elastically deformable features. For example, an embodiment of the elastically averaged alignment system 10 includes a second alignment element 304 fixedly disposed with respect to and extending outward from the surface 106 of the first alignment member 102, the second alignment element 304 being spaced apart from the first alignment element 104 a first defined distance 180, and a second alignment aperture 604 fixedly disposed with respect to the second alignment member 202, the second alignment aperture 604 being space apart from the first alignment aperture 204 a second defined distance 280. Similar to the first alignment element 104 and first alignment aperture 204, the second alignment element 304 is disposed to engage with the second alignment aperture 604, such that when the second alignment element 304 is inserted into the second alignment aperture 604, portions of at least one of the second alignment element 304 and the second alignment aperture 604 elastically deform to an elastically averaged final configuration that further aligns the first alignment member 102 with the second alignment member 202 in at least two planar orthogonal directions.

In an embodiment, the second alignment element 304 is an elongated deformable hollow circular tube (also herein referred to by reference numeral 304) that may or may not have a plurality of slots 306 oriented parallel to a central axis of the tube 304. While FIG. 1 depicts the elongated deformable hollow circular tube 304 with the plurality of slots 306, it will be appreciated that the scope of the invention also encompasses an elongated deformable hollow circular tube 304 absent the plurality of slots 306. It will also be appreciated that the distal end 310 of the tube 304 may include a chamfer, similar to that depicted by reference numeral 108 on the first alignment element 104, to assist with the insertion of the second alignment element 304 into the second alignment aperture 604 during an assembly process.

In an embodiment, the second alignment aperture 604 may be an elongated slot aperture as depicted in FIG. 1, or may be a circular aperture, where either aperture is suitably sized to interferingly, deformably and matingly engage with the second alignment element 304. In an embodiment, the second alignment aperture 604 includes a chamfer 608 around the perimeter thereof on the mating side, surface 206, of the second alignment member 202 to assist with the insertion of the second alignment element 304 into the second alignment aperture 604 during an assembly process. An elastically averaged alignment system 10 utilizing an elastically deformable elongated hollow tube similar to that of tube 304, and a slot or circular aperture similar to that of slot aperture 306, is described in detail in commonly owned, co-pending U.S. patent application Ser. No. 13/187,675, the disclosure of which having already been incorporated by reference in its entirety as discussed above.

In an embodiment, the elastically deformable alignment aperture 204, and more specifically the first opening 210 of the elastically deformable alignment aperture 204, may also include a chamfer around the perimeter thereof similar to that of chamfer 608 to further assist with the insertion of the first alignment element 104 into the first elastically deformable alignment aperture 204 during an assembly process.

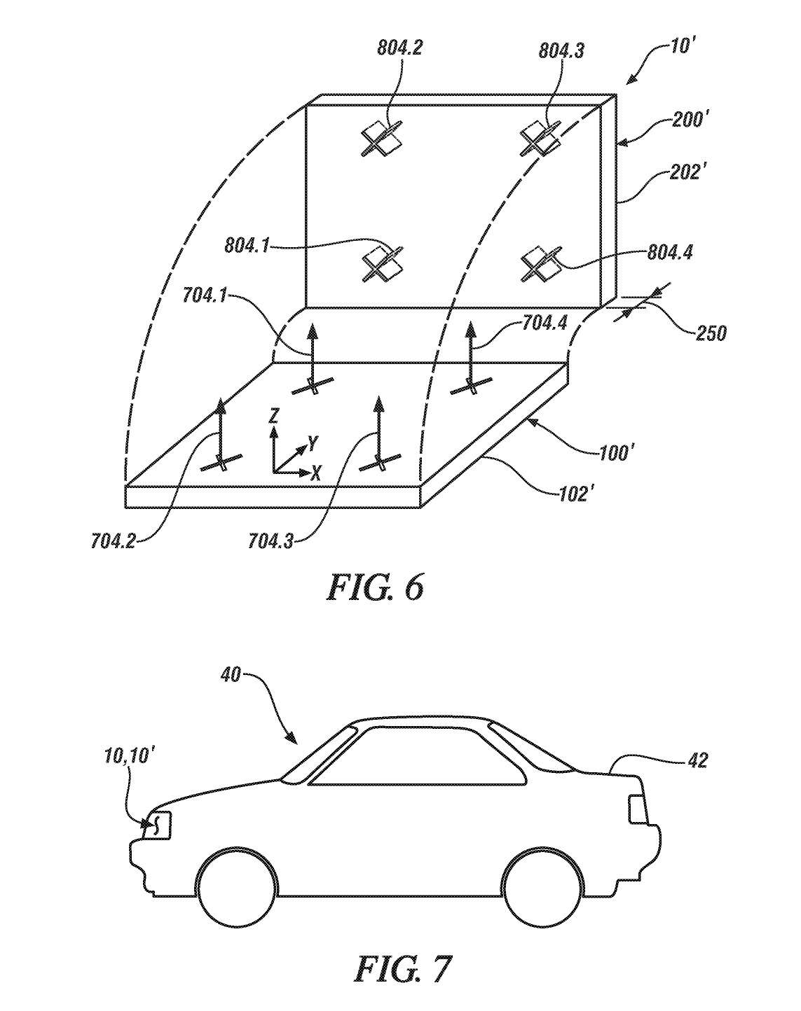

From all of the foregoing, and with reference now to FIG. 6, it will be appreciated that an embodiment of an elastically averaged alignment system 10′ may include any of the combinations of the alignment elements and respective alignment apertures as described herein. FIG. 6 depicts a first component 100′ having a first alignment member 102′, and a second component 200′ having a second alignment member 202′ with a thickness 250, similar to the un-primed counterparts depicted in FIG. 1. In FIG. 6, the X-based-arrowhead-graphics 704.1, 704.2, 704.3, 704.4 represent alignment elements, such as the alignment element 104 or the elastically deformable alignment element 304 described herein, and the 3D-X-graphics 804.1, 804.2, 804.3, 804.4 represent alignment apertures, such as the elastically deformable alignment aperture 204, the elastically deformable alignment aperture 404, or the alignment aperture 604 described herein, pierced through the thickness 250. As depicted in FIG. 6, the alignment elements and alignment apertures are configured and disposed to interferingly, deformably and matingly engage with each other in the following pairs: 704.1 and 804.2; 704.2 and 804.2; 704.3 and 804.3; and, 704.4 and 804.4. While only four pairs of alignment elements and alignment apertures are depicted in FIG. 6, it will be appreciated that the scope of the invention is not so limited and encompasses any number of pairs of alignment elements and alignment apertures suitable for a purpose disclosed herein.

In a first example embodiment, the alignment elements 704.1 and 704.2 each have the structure of alignment element 104, the alignment apertures 804.1 and 804.2 each have the structure of elastically deformable aperture 204 or elastically deformable aperture 404, the alignment elements 704.3 and 704.4 each have the structure of alignment element 304 (with or without slots 306), and the alignment apertures 804.3 and 804.4 each have the structure of alignment slot aperture 604 oriented as depicted in FIG. 1 with the major axis of each slot disposed parallel to the y-axis. In this first example embodiment, the resulting elastically averaged alignment system 10′ would have its left two corners (as viewed from the perspective of FIG. 6) elastically constrained in four-way alignment, thereby tightly constraining the left two corners in both the +/−x-direction and the +/−y-direction, and would have its right two corners elastically constrained in two-way alignment with the right side edge of the elastically averaged alignment system (assembly) 10′ being more constrained in the +/−x-direction than in the +/−y-direction.

In a second example embodiment, the alignment elements 704.1 and 704.2 each have the structure of alignment element 104, the alignment apertures 804.1 and 804.2 each have the structure of elastically deformable aperture 204 or elastically deformable aperture 404, the alignment elements 704.3 and 704.4 each have the structure of alignment element 304 (with or without slots 306), and the alignment apertures 804.3 and 804.4 each have the structure of alignment slot aperture 604 oriented perpendicular to that depicted in FIG. 1 with the major axis of each slot disposed parallel to the x-axis. In this second example embodiment, the resulting elastically averaged alignment system 10′ would have its left two corners (as viewed from the perspective of FIG. 6) elastically constrained in four-way alignment, thereby tightly constraining the left two corners in both the +/−x-direction and the +/−y-direction, and would have its right two corners elastically constrained in two-way alignment with the right two corners of the elastically averaged alignment system (assembly) 10′ being more constrained in the +/−y-direction than in the +/−x-direction.

In a third example embodiment, instead of mating the alignment element 104 with either of the elastically deformable alignment apertures 204, 404 as previously discussed herein, the elastically averaged alignment system 10′ may be configured to mate the elastically deformable alignment element 304 with either of the elastically deformable alignment apertures 204, 404, which would provide an additional degree of elastic deformation in the overall elastically averaged alignment system 10′.

It will be appreciated from the foregoing examples that such examples are only a few of the many combinations of alignment features and alignment apertures that could be utilized together in a manner suitable to provide an elastically averaged alignment system as disclosed herein. All such combinations are contemplated and considered to be within the scope of the invention disclosed herein.

In view of all of the foregoing, and with reference now to FIG. 7, it will be appreciated that there may be many applications where one or more elastically deformable alignment apertures 204, 404 with mating alignment elements 104, 304 may be utilized in an elastically averaged alignment system 10 to align the first and second components 100, 200 with respect to each other. For example, an embodiment of the invention also includes a vehicle 40 having a body 42 with an elastically averaging alignment system 10, 10′ as herein disclosed integrally arranged with the body 42. In the embodiment of FIG. 7, the elastically averaging alignment system 10, 10′ is depicted forming at least a portion of a front grill of the vehicle 40, where the first component 100 is in the form of a first portion of the vehicle 40, such as the front grill for example, and where the second component 200 is in the form of a second portion of the vehicle 40, such as the support structure that holds the grill to the body 42 for example. In addition to the foregoing, it is further contemplated that an elastically averaging alignment system 10, 10′ as herein disclosed may be utilized with other structural features of the vehicle 40, such as interior trim or elements of a glove box door, for example.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system, comprising:
a first component comprising a first alignment member and an alignment element fixedly disposed with respect to and extending outward from a surface of the first alignment member;
a second component comprising a second alignment member and an elastically deformable alignment aperture fixedly disposed with respect to the second alignment member;
wherein the elastically deformable alignment aperture is configured and disposed to interferingly, deformably and matingly engage with the alignment element;
wherein the elastically deformable alignment aperture comprises three or more elastically deformable alignment features; and
wherein when the alignment element is inserted into the elastically deformable alignment aperture, portions of the three or more elastically deformable alignment features elastically deform to an elastically averaged final configuration that aligns the first alignment member with the second alignment member in four planar orthogonal directions.

2. The elastically averaged alignment system of claim 1, wherein:
each of the three or more elastically deformable alignment features comprises an elastically deformable fixed beam.

3. The elastically averaged alignment system of claim 1, wherein:
each of the three or more elastically deformable alignment features comprises an elastically deformable cantilevered beam.

4. The elastically averaged alignment system of claim 1, wherein:
each of the three or more elastically deformable alignment features are configured to elastically deform radially outward from a center of the elastically deformable alignment aperture.

5. The elastically averaged alignment system of claim 3, wherein:
each of the three or more elastically deformable alignment features are configured to elastically deform circumferentially about an outer circumference of the alignment element.

6. The elastically averaged alignment system of claim 3, wherein:
each of the three or more elastically deformable alignment features are configured to elastically deform axially with respect to a central axis of the alignment element.

7. The elastically averaged alignment system of claim 3, wherein:
each of the three or more elastically deformable alignment features comprises a proximal end that is smaller in cross section area than a distal end thereof.

8. The elastically averaged alignment system of claim 3, wherein:
each of the three or more elastically deformable alignment features comprises a proximal end that is larger in cross section area than a distal end thereof.

9. The elastically averaged alignment system of claim 1, wherein:
the alignment element and the elastically deformable alignment aperture comprise male and female mating features, respectively.

10. The elastically averaged alignment system of claim 2, wherein:
the elastically deformable alignment aperture comprises four openings.

11. The elastically averaged alignment system of claim 10, wherein:
each elastically deformable fixed beam is disposed to form one side of an equilateral triangle shape.

12. The elastically averaged alignment system of claim 1, wherein:
the alignment element comprises an elongated solid circular pin.

13. The elastically averaged alignment system of claim 1, wherein:
the alignment element comprises an elongated elastically deformable hollow circular tube.

14. The elastically averaged alignment system of claim 13, wherein:
the elongated elastically deformable hollow circular tube comprises a plurality of slots oriented parallel to a central axis of the tube.

15. The elastically averaged alignment system of claim 1, wherein:
the alignment element comprises a proximal end proximate the first alignment member, and a distal end distal to the first alignment member, the distal end comprising a taper

16. The elastically averaged alignment system of claim 1, wherein:
the elastically deformable alignment aperture comprises a chamfer on a mating side of the second alignment member.

17. The elastically averaged alignment system of claim 1, wherein the alignment element is a first alignment element and the elastically deformable alignment aperture is a first alignment aperture, and further wherein:
the first component further comprises a second alignment element fixedly disposed with respect to and extending outward from a surface of the first alignment member, the second alignment element being spaced apart from the first alignment element a first defined distance;
the second component further comprises a second alignment aperture fixedly disposed with respect to the second alignment member, the second alignment aperture being space apart from the first alignment aperture a second defined distance;
the second alignment element is disposed to engage with the second alignment aperture; and
when the second alignment element is inserted into the second alignment aperture, portions of at least one of the second alignment element and the second alignment aperture elastically deform to an elastically averaged final configuration that further aligns the first alignment member with the second alignment member in at least two planar orthogonal directions.

18. The elastically averaged alignment system of claim 1, wherein:
the first component comprises a first portion of a vehicle; and
the second component comprises a second portion of the vehicle.

19. The elastically averaged alignment system of claim 1, wherein the first component comprises more than one of the alignment element and the second component comprises more than one of the elastically deformable alignment aperture, the more than one alignment elements being geometrically distributed with respect to respective ones of the more than one elastically deformable alignment apertures, such that portions of the elastically deformable alignment apertures of respective ones of the more than one elastically deformable alignment apertures, when engaged with respective ones of the more than one alignment element, elastically deform to an elastically averaged final configuration that further aligns the first alignment member with the second alignment member in at least two of four planar orthogonal directions.
